(19) United States
(12) Patent Application Publication
(10) Pub. No.: US 2013/0087114 A1
(43) Pub. Date: Apr. 11, 2013

(54) METHOD AND DEVICE FOR REDUCING THE TEMPERATURE TOLERANCE OF SHEATHED-ELEMENT GLOW PLUGS

(71) Applicant: Sascha Joos, Dresden (DE)

(72) Inventor: Sascha Joos, Dresden (DE)

(21) Appl. No.: 13/639,416

(22) PCT Filed: Apr. 13, 2011
(86) PCT No.: PCT/EP2011/055772

§ 371 Date: Dec. 18, 2012

(30) Foreign Application Priority Data
May 18, 2010 (DE) 10 2010 029 047.5

(51) Int. Cl. F02P 19/02

(52) U.S. Cl. CPC F02P 19/021
USPC 123/179.21

(57) ABSTRACT

A method for reducing the temperature tolerance of sheathed-element glow plugs is described, in which, in a first step, the sheathed-element glow plugs of an auto-ignition internal combustion engine are classified into at least two temperature classes, at least one temperature class including a temperature range above a setpoint temperature range, at least one temperature class including a temperature range below the setpoint temperature range, and/or one temperature class including the setpoint temperature range. In a second step, the control voltage of sheathed-element glow plugs which were assigned to a temperature class which includes a temperature range above the setpoint temperature range is reduced, and the control voltage of sheathed-element glow plugs which were assigned to a temperature class which includes a temperature range below the setpoint temperature range is increased. A device for performing the method is also described.

### FIELD OF THE INVENTION

The present invention relates to a method for reducing the temperature tolerance of sheathed-element glow plugs. Furthermore, the present invention relates to a device for reducing the temperature tolerance of sheathed-element glow plugs.

### BACKGROUND INFORMATION

At low temperatures, auto-ignition internal combustion engines require an ignition aid. In particular, the ignition aid is required for starting the internal combustion engine. Sheathed-element glow plugs are used for this purpose, which are each installed in the cylinder head and protrude into the combustion chamber. The sheathed-element glow plugs typically include a glow plug, which provides a hot point to the fuel-air mixture to be ignited, on which the fuel-air mixture may ignite.

In typically used sheathed-element glow plugs, the glow plug includes a heating element designed as an electrical resistor. A voltage is applied to the heating element, so that a current, which heats the glow plug to a defined temperature, flows through the heating element. This temperature is selected in such a way that it is sufficient to ignite the fuel-air mixture in the combustion chamber of the internal combustion engine. The temperature of the glow plug results from the applied voltage and the cooling of the glow plug from the running internal combustion engine. Depending on the engine state, the temperature may be set using the level of the applied voltage. In order for the glow plug to have the correct temperature during the start-up of the internal combustion engine and during the warm-up phase, the glow system, which includes sheathed-element glow plug, control unit, and software, must be adapted.

The temperature to which the glow plug of a sheathed-element glow plug is heated is typically in the range from 800° C. to 1300° C. In general, sheathed-element glow plugs have a manufacturing-related temperature tolerance. This is generally approximately +/−50° C. The temperature differences of the individual sheathed-element glow plugs, which result from the temperature tolerance during manufacturing, cause a negative influence of the combustion behavior during a cold start and the emission operation, however. In addition, the service life of individual sheathed-element glow plugs is reduced due to temperature deviations.

### SUMMARY

An example method according to the present invention for reducing the temperature tolerance of sheathed-element glow plugs includes the following steps:
(a) classifying the sheathed-element glow plugs of an auto-ignition internal combustion engine into at least two temperature classes, at least one temperature class including a temperature range above a setpoint temperature range, at least one temperature class including a temperature range below the setpoint temperature range, and/or one temperature class including the setpoint temperature range,
(b) reducing the control voltage of sheathed-element glow plugs which were assigned to a temperature class which includes a temperature range above the setpoint temperature range, and increasing the control voltage of sheathed-element glow plugs which were assigned to a temperature class which includes a temperature range below the setpoint temperature range.

The temperature tolerance of the sheathed-element glow plugs may be reduced by the method according to the present invention. In particular, the tolerance chain, including wiring harness, contact resistors, and sheathed-element glow plug, is taken into consideration by the method. Improved behavior during a cold start may be achieved and the emission operation may be improved by the reduction in the temperature tolerance. In addition, a longer service life of the sheathed-element glow plugs may be achieved.

The combustion stability during a cold start is increased and the hydrocarbon and carbon monoxide emissions are reduced due to the improvement of the glow behavior and the combustion behavior.

Another advantage is that the example method may be performed on the internal combustion engine during running operation, so that no external adjustment is necessary. In addition, this has the advantage that regular monitoring of the temperature tolerances may be performed.

In order to perform the example method, the present invention also includes an example device for reducing the temperature tolerance of sheathed-element glow plugs, including an arrangement for classifying the sheathed-element glow plugs into at least two temperature classes, at least one temperature class including a temperature range above a setpoint temperature range, at least one temperature class including a temperature range below the setpoint temperature range, and/or one temperature class including the setpoint temperature range, as well as an arrangement for adapting the control voltage of the sheathed-element glow plugs as a function of the temperature class to which the sheathed-element glow plug was assigned.

A glow time control unit, as is already currently used in internal combustion engines, is preferably used as the arrangement for classifying the sheathed-element glow plugs and the arrangement for adapting the control voltage of the sheathed-element glow plugs.

This also allows the example method according to the present invention to be adapted to internal combustion engines which are already in operation.

In a first embodiment of the present invention, current, voltage, and activation time are measured and features for classification are calculated therefrom to classify the sheathed-element glow plugs. For example, power, resistance, energy, and time constant T₆₃, T₁₀₀ are calculated as features for classification. The time constant takes into consideration the change in the temperature over time or the resistance of the sheathed-element glow plug in the event of a change in the control voltage (voltage jump).

Power, resistance, E, and T₆₃ and T₁₀₀ may already be determined from current, voltage, and activation time using currently employed glow time control units. This allows a simple adaptation of the method according to the present invention to already existing systems. A further advantage is that the sheathed-element glow plugs may be classified without great technical complexity. In order to classify the sheathed-element glow plugs, the features for classification, for example, power, resistance, E, and T₆₃, T₁₀₀ are compared to predefined reference values. In a first specific embodiment, the predefined reference values are reference values which are externally predefined and are stored in the glow time control unit or another device for calculating the features for classification.

In one alternative specific embodiment, the features of the individual sheathed-element glow plugs of the internal combustion engine are compared to one another. For example, if the features of one sheathed-element glow plug differ significantly from the features of the other sheathed-element glow plugs of the internal combustion engine in this case, this sheathed-element glow plug is classified in the temperature class above the setpoint temperature range or in the temperature class below the setpoint temperature range, depending on how the features differ. For example, the sheathed-element glow plug is classified in the temperature class which includes the temperature range above the setpoint temperature range if it converts significantly more power at the same control voltage in comparison to the other sheathed-element glow plugs. Correspondingly, a sheathed-element glow plug which converts less power in relation to the other sheathed-element glow plugs of the internal combustion engine at the same control voltage is classified in the temperature class which covers the temperature range below the setpoint temperature range. In order to be able to classify each of the sheathed-element glow plugs into the temperature classes in this case, it is preferable in particular if the features of all sheathed-element glow plugs of the internal combustion engine are compared to one another for the classification, a range being established as the setpoint value range into which the features of at least two sheathed-element glow plugs fall in the case of more than three sheathed-element glow plugs, and into which the features fall which establish a mean temperature in the case of three sheathed-element glow plugs.

In addition, if values exceed or fall below diagnostic limiting values, the glow plug may be recognized as defective, no voltage adaptation being performed in this case. Diagnostic limiting values are resistances which are well outside the possible manufacturing tolerance band, for example. Thus, for example, the resistance may be extremely high, i.e., significantly greater than a possible tolerance value and may go toward infinity in the limiting case, which indicates a broken heater line. Furthermore, the resistance may have a very small value, which goes toward 0 ohm in the limiting case, which indicates a short circuit.

In addition to the features which are calculated from the measured variables, for example, current, voltage, and activation time, tolerance specifications from the manufacturing or the installation configuration of the sheathed-element glow plugs within the internal combustion engine may also be taken into consideration, in order to also take into consideration the probability of whether the sheathed-element glow plug is a hot or cold sheathed-element glow plug and is to be classified for this purpose in the temperature class which covers the temperature range above the setpoint temperature range or in the temperature class which covers the temperature range below the setpoint temperature range.

After the classification of the sheathed-element glow plugs into the temperature classes, the control voltage is reduced for the sheathed-element glow plugs which were assigned to a temperature class which covers the temperature range above the setpoint temperature range, and the control voltage is increased for the sheathed-element glow plugs which were assigned to a temperature class which includes a temperature range below the setpoint temperature range. The control voltage is not corrected in the case of sheathed-element glow plugs which fall into the temperature class which includes the setpoint temperature range. By increasing the control voltage, the sheathed-element glow plug converts more power and the temperature of the sheathed-element glow plug rises. Correspondingly, the sheathed-element glow plug converts less power in the event of a reduced control voltage and the sheathed-element glow plug heats up to a lower temperature. In particular in the case of more than only one temperature class, which each include the temperature ranges above the setpoint temperature range and below the setpoint temperature range, a different increase or reduction in the control voltage may also be implemented on the basis of the temperature class into which the sheathed-element glow plug was classified. The more the temperature deviates from the setpoint temperature, the stronger is the change in the control voltage in this case.

Through the correction of the control voltage, the sheathed-element glow plugs, which were classified in the temperature class which includes a temperature range below the setpoint temperature range or in the temperature class which includes a temperature range above the setpoint temperature range, may be moved into a target temperature tolerance band, which typically corresponds to the setpoint temperature range. The target temperature tolerance is typically at a temperature deviation from a setpoint temperature of ΔT=25° C. For the setpoint temperature range, this means that it includes a temperature difference of 50° C. between minimum and maximum temperatures.

The example method according to the present invention for the classification of the sheathed-element glow plugs and the adaptation is preferably performed when the motor vehicle is stationary with activated ignition or after the ignition is turned off, when the control unit is in overrun.

Alternatively, for example, it is also possible to perform the measurement during idling of the internal combustion engine, since a constant speed and injection quantity and therefore a stationary operating point exist here. During the measurement, the sheathed-element glow plugs are individually activated. By performing the method when the vehicle is stationary, for example, immediately after starting the internal combustion engine or, for example, during a traffic signal stop, it is ensured that changes in the performance of the engine do not occur during travel due to the setting of the sheathed-element glow plugs. In addition, the engine is typically moved at idle speed when the vehicle is stationary, so that a constant speed level is provided for setting and adapting the sheathed-element glow plugs.

In one specific embodiment of the present invention, the features for the classification are initially compared to predefined reference values, in order to classify the sheathed-element glow plugs, and subsequently, for verification, the features of all sheathed-element glow plugs of the internal combustion engine are compared to one another for classification, a range being established as the setpoint value range into which the features of at least two sheathed-element glow plugs fall in the case of more than three sheathed-element glow plugs and into which the features fall which establish a mean temperature in the case of three sheathed-element glow plugs. An additional security step for the adaptation of the control voltage is provided by the comparison to predefined reference values and the comparison of the features of the sheathed-element glow plugs among one another.

Through the example method according to the present invention, it is possible to reduce the temperature tolerance of sheathed-element glow plugs both in controlled operation and also in regulated operation of the internal combustion engine. The glow behavior or the combustion behavior of the internal combustion engine is improved by the reduction in the temperature tolerance of the sheathed-element glow plugs. This results in combustion stability during a cold start and a reduction in hydrocarbon and carbon monoxide emissions. A further advantage of the method according to the present invention is that the adaptation of the temperature tolerance of the sheathed-element glow plugs may be performed without additional technical complexity and without additional devices. It is also possible through the adaptation of the temperature tolerance of the sheathed-element glow plugs directly in the internal combustion engine to use sheathed-element glow plugs having a greater temperature tolerance band from the manufacturing, so that a lower rejection rate results during the manufacturing.

In particular, the example method according to the present invention has the advantage that by setting the temperature tolerance of the sheathed-element glow plugs, on the one hand, the specified glow temperature in the motor vehicle may be maintained better and, on the other hand, the glow temperature may be increased or the sheathed-element glow plug service life in the internal combustion engine may be lengthened.

### BRIEF DESCRIPTION OF THE DRAWINGS

Exemplary embodiments of the present invention are shown in the FIGURE and are explained in greater detail in the following description.

The FIGURE shows voltage, temperature, and resistance curves as a function of time.

### DETAILED DESCRIPTION OF EXAMPLE EMBODIMENTS

The curves of temperature, resistance, and voltage as a function of time are shown in the single FIGURE.

To classify sheathed-element glow plugs which are outside a predefined temperature tolerance, features which describe the dynamic behavior and the stationary behavior of the sheathed-element glow plug are initially calculated. For this purpose, it is possible, for example, to activate the sheathed-element glow plug using a predefined control voltage in an internal combustion engine of a motor vehicle when the motor vehicle is stationary and therefore the surrounding air is calm, in order to determine the features of the sheathed-element glow plug. Over the entire period of time of the classification and the registration of the temperature tolerance of the sheathed-element glow plug, voltage and current are measured and characteristic values are calculated at predefined timestamps. The calculated characteristic values are, for example, the resistance of the sheathed-element glow plug, the power of the sheathed-element glow plug, time constant T₆₃, i.e., the time until 63% of the setpoint value or target value is reached, the time being determined with the aid of a timer in the control unit, the time to achieve a specific resistance level, and gradients dT/dR.

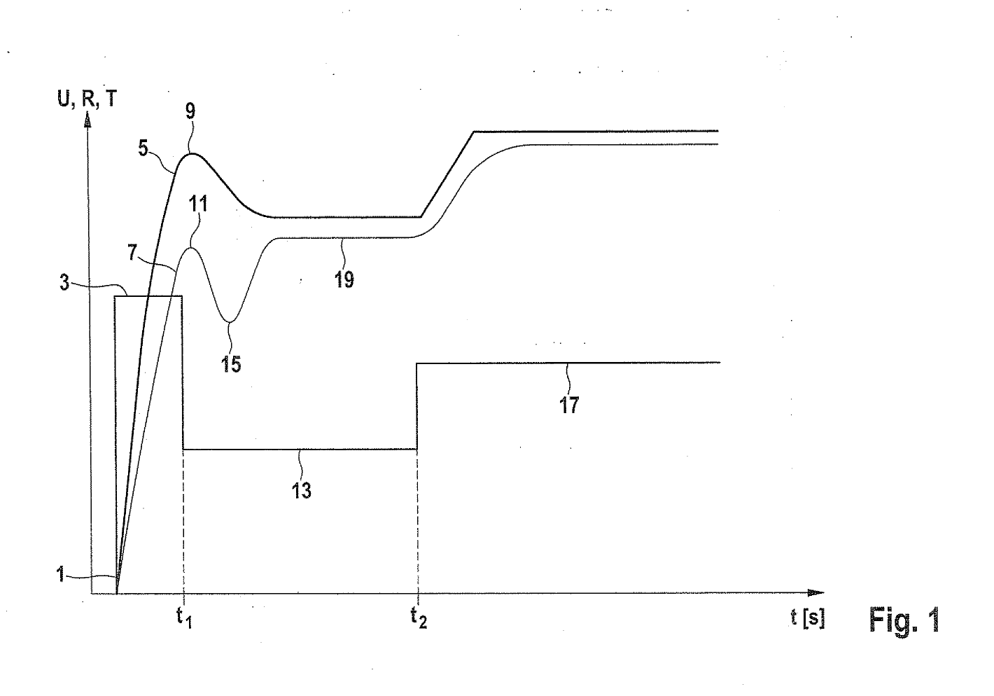

The determination of the characteristic features for a sheathed-element glow plug is shown, for example, in FIG. 1. For this purpose, an initial resistance R₀ is determined at a starting point in time 1 in a first step. At the starting point in time, the control voltage is increased to a first value 3. By increasing the control voltage to first value 3, temperature 5 of the sheathed-element glow plug increases and resistance 7 also increases because of the rising temperature.

In order to achieve a rapid temperature increase of the sheathed-element glow plug, first value 3 for the control voltage is higher than the later control voltage of the sheathed-element glow plug. At the end of the starting procedure at a point in time t₁, a first temperature maximum 9 and a first resistance maximum 11 have resulted. At point in time t₁, the voltage is reduced to a second value 13. The point in time at which the control voltage is reduced to second value 13 is determined by

$${\int }_{t} {U}^{2} d t > {E}_{thres} \qquad ( 1 )$$

where U is the control voltage, t is the time, and Eₜₕᵣₑₛ is the energy threshold, which is defined in such a way that the sheathed-element glow plug does not exceed the permissible temperature maximum during the rapid heating phase (pushing, Uₚᵤₛₕ>>Uₙₒₘᵢₙₐₗ). The energy may either be determined according to equation 1, i.e., with the aid of the integral of (U²/R), where R=1 in equation 1, or alternatively by the integral of (U*I) according to equation (2).

$${\int }_{t} ( U \cdot I ) d t > {E}_{thres} \qquad ( 2 )$$

After the reduction in the control voltage to second value 13, both resistance 7 and also temperature 5 decrease. A local minimum 15 results for resistance 7. This is calculated.

After a predefined time t₂, the voltage is increased to a third value. Third value 17 of the control voltage is higher than second value 13 and lower than first value 3. Typical values for the control voltage are, for example, 11 V for the first value, 3.0 V or 5.5 V for the second value, and 5 V, 7 V, or 7.5 V for the third value. In general, the first value for the control voltage is in the range between 9 V and 13 V, the second value for the control voltage is in the range between 2 V and 6 V, and the third value for the control voltage is in the range between 4 V and 9 V.

After local minimum 15 of resistance 7, it increases again. A constant value 19 results for the resistance in this case. Constant value 19 is determined. Immediately before the control voltage is increased to the third value, constant value 19 is determined again. After the control voltage is increased to third value 17, the resistance and therefore also the power are again determined. To check whether a constant resistance or a constant power results, the resistance is determined again at the end of the measuring procedure.

The sheathed-element glow plug is classified in a temperature class on the basis of the measured and determined values. Three temperature classes are typically used for this purpose, one temperature class including a temperature range above a setpoint temperature range, one temperature class including a temperature range below the setpoint temperature range, and one temperature class including the setpoint temperature range.

The measured values are compared to stored values to classify the sheathed-element glow plugs in one of the temperature classes. The values may be stored in a glow time control unit, for example.

For example, the sheathed-element glow plugs are classified according to the following criteria:

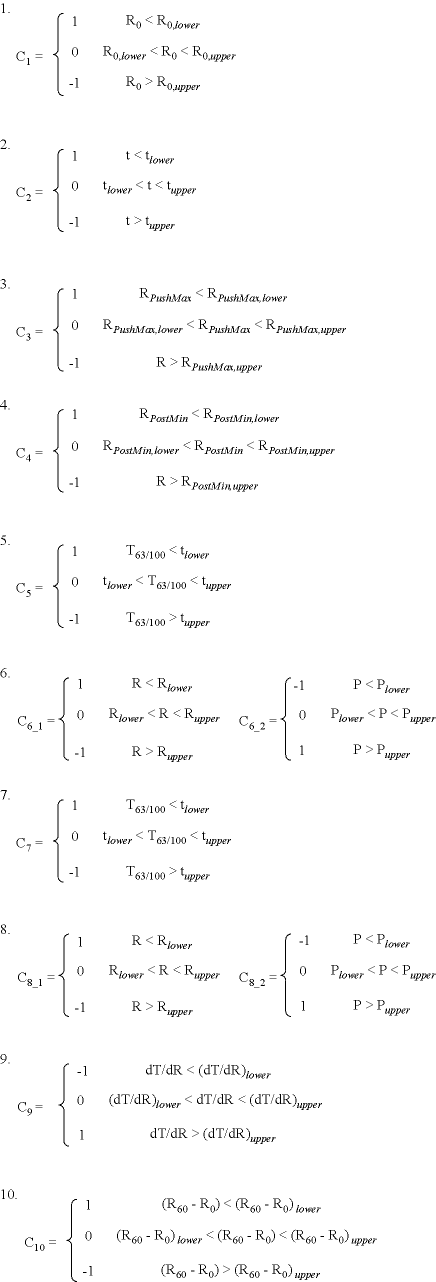

In the above assignments, 1 denotes an assignment to the temperature class which includes the temperature range above the target temperature range, −1 denotes the temperature class which includes the temperature range below the setpoint temperature range, and 0 denotes the temperature class which includes the setpoint temperature range.

In the assignments:

### C1:

R₀: Denotes cold resistance of the glow plug, resistance when the sheathed-element glow plug is turned on.
R_{0,lower}: Denotes lower limit for the cold resistance, so that the glow plug may be classified on the basis of this criterion as a nominal glow plug.
R_{0,upper}: Denotes upper limit for the cold resistance, so that the glow plug may be classified on the basis of this criterion as a nominal glow plug.

### C2:

t: Denotes time from energizing of the glow plug until reaching the maximum resistance (time from point 1 to 11),
t_{lower}: Denotes lower limit for the time so that the glow plug may be classified on the basis of this criterion as a nominal glow plug.
tᵤₚₚₑᵣ: Denotes upper limit for the time so that the glow plug may be classified on the basis of this criterion as a nominal glow plug.

### C3:

R_{PushMax}: Denotes maximum resistance after the pushing (rapid heating), i.e., resistance after the application of the high voltage at point 3 of 11 V, for example. Indices lower, upper similar to C1, C2, but in the case for the resistance after the pushing (maximum resistance after the pushing).

### C4:

R_{PostMin}: Denotes minimum resistance after the pushing and application of a lower voltage of, e.g., 5.5 V (point 13).

### C5:

Denotes time constant until 63% or 100% of the stationary resistance is reached upon application of a voltage of 5.5 V, for example. The initial value is the minimum resistance after the pushing, i.e., the difference between R (5.5 V stationary) and R_{PostMin}, ΔR=R (5.5 V)−R_{PostMin} is calculated. The time constant is then determined from the time difference (Δt=t (5.5 V)−t(R_{PostMin})) from R_{PostMin} until reaching 63% or 100% of R (5.5 V). T₆₃=63% of Δt or T₁₀₀=100% of Δt.

### C6:

R: Denotes resistance (calculated from measured voltage U and current intensity I) between t₁ and t₂; the resistance of the glow plug is stationary and represents a stationary temperature value of the glow plug. Alternatively, power P may also be determined in this phase.

### C7:

Denotes time constant until 63% or 100% of the stationary resistance is reached upon application of a voltage of 7.4 V, for example. The initial value is the stationary resistance between t₁ and t₂, i.e., the difference between R (7.4 V) and R (5.5 V), ΔR=R (7.4 V)−R (5.5 V) is calculated. The time constant is then determined from the time difference (Δt−t (7.4 V)−t(5.5 V)) from R (5.5 V) until reaching 63% or 100% of R (7.4 V). T₆₃=63% of Δt or T₁₀₀=100% of Δt.

### C8:

Similar to C6, but for the phase t>t₂.

### C9:

dT/dR=(T (7.4 V)−T (5.5 V))/(R (7.4 V)−R (5.5 V)), T=temperature, 7.4 V exemplary voltage in the phase t>t₂ and 5.5 V for t₁<t<t₂. The reference temperatures for the reference voltage (e.g., 5.5 V and 7.4 V) are stored in the control unit.

### C 10:

R₆₀-R₀: Denotes resistance difference between stationary end value (R₆₀ corresponds in this case to resistance R of C6_{—}1 or resistance R of C8_{—}1) in the time range t₁<t<t₂ or for t>t₂ and cold resistance R₀ (C1).

To find a criterion for which temperature class the sheathed-element glow plug is finally assigned to, the individual classifications are each multiplied by a weighting factor and added. If the value thus determined is greater than an upper predefined value, the sheathed-element glow plug is assigned to the temperature class which is above the setpoint temperature range, if the determined value is less than a lower predefined limiting value, the sheathed-element glow plug is assigned to the temperature class which includes the temperature range below the setpoint temperature range, and if the value is between the upper limiting value and the lower limiting value, the glow plug is assigned to the temperature class which includes the setpoint temperature range.

If the sheathed-element glow plug is assigned to the temperature class which includes the temperature range below the setpoint temperature range, the control voltage is increased, and if the sheathed-element glow plug is assigned to the temperature class which includes the temperature range above the setpoint temperature range, the control voltage is reduced.

Alternatively, it is also possible to change the resistance of the sheathed-element glow plug instead of the control voltage. In this case, the voltage is also changed, but not “all at once” using a fixed defined constant correction voltage, but rather in such a way that a requested resistance results. The voltage is varied until a desired temperature and therefore a certain resistance results at the sheathed-element glow plug. For example, if the resistance is too low, more power is converted and the glow plug is too hot. In this case, the voltage is reduced until a requested resistance is reached.

In one alternative specific embodiment, it is also possible to compare the sheathed-element glow plugs to one another. For this purpose, the same calculated features may be used as described above, for example, power, resistance, current, T₆₃, or also gradients.

After the determination of the features, for example, the temperature class to which the sheathed-element glow plug is to be assigned may be estimated on the basis of a probability model.

A classification into temperature ranges is typically already performed during the production of the sheathed-element glow plugs. They are typically classified as cold sheathed-element glow plugs, moderate sheathed-element glow plugs, and hot sheathed-element glow plugs. During further use, sheathed-element glow plugs from the same group are installed in each case in an internal combustion engine.

However, the temperature ranges in which the sheathed-element glow plugs are classified during the production are generally greater than the desired temperature tolerance for the internal combustion engine. It is always possible, however, that sheathed-element glow plugs from different temperature classes are also installed in an internal combustion engine. In this case, the temperature tolerance may be set by adapting the control voltage, for example, through the method according to the present invention.

1-9. (canceled)

10. A method for reducing a temperature tolerance of sheathed-element glow plugs, comprising:
classifying the sheathed-element glow plugs of an auto-ignition internal combustion engine into at least two temperature classes, at least one of: i) at least one temperature class including a temperature range above a setpoint temperature range, ii) at least one temperature class including a temperature range below the setpoint temperature range, and iii) at least one temperature class including the setpoint temperature range; and
reducing a control voltage of sheathed-element glow plugs which were assigned to a temperature class which includes a temperature range above the setpoint temperature range, and increasing the control voltage of sheathed-element glow plugs which were assigned to a temperature class which includes a temperature range below the setpoint temperature range.

11. The method as recited in claim 10, wherein current, voltage, and activation time are measured for the classification and features for the classification are calculated therefrom.

12. The method as recited in claim 11, wherein power, resistance, energy, and time constant are calculated as features for the classification.

13. The method as recited in claim 11, wherein the features for the classification are compared to predefined reference values to classify the sheathed-element glow plugs.

14. The method as recited in claim 11, wherein the features of all sheathed-element glow plugs of the internal combustion engine are compared to one another for the classification, a range being established as the setpoint value range, into which the features of at least two of the sheathed-element glow plugs fall in the case of more than three sheathed-element glow plugs, and into which the features fall which establish a mean temperature in the case of three sheathed-element glow plugs.

15. The method as recited in claim 10, wherein the classifying of the sheathed-element glow plugs and the reducing and increasing are performed while the vehicle is stationary.

16. The method as recited in claim 11, wherein the features for the classification are initially compared to predefined reference values to classify the sheathed-element glow plugs, and subsequently the features of all sheathed-element glow plugs of the internal combustion engine are compared to one another for the classification, a range being established as the setpoint value range, into which the features of at least two of the sheathed-element glow plugs fall in the case of more than three sheathed-element glow plugs, and into which the features fall which establish a mean temperature in the case of three of the sheathed-element glow plugs.

17. A device for reducing a temperature tolerance of sheathed-element glow plugs, comprising:
an arrangement configured to classify the sheathed-element glow plugs into at least two temperature classes, at least one of: i) at least one temperature class including a temperature range above a setpoint temperature range, ii) at least one temperature class including a temperature range below the setpoint temperature range, and iii) at least one temperature class including the setpoint temperature range; and
an arrangement to adapt a control voltage of the sheathed-element glow plugs as a function of the temperature class to which the sheathed-element glow plug was assigned.

18. The device as recited in claim 17, wherein the arrangement to classify the sheathed-element glow plugs and the arrangement to adapt the control voltage of the sheathed-element glow plugs include a glow time control unit.
